(19) United States
(12) Patent Application Publication
(10) Pub. No.: US 2007/0084759 A1
(43) Pub. Date: Apr. 19, 2007

(54) Magnetic sweeper capable of collecting and releasing metal objects therefrom

(76) Inventor: Hsuan-Sen Shiao, Taichung Hsien (TW)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/342,675

(22) Filed: Jan. 31, 2006

(30) Foreign Application Priority Data
Oct. 19, 2005 (TW) 094136481

(51) Int. Cl. B03C 1/00

(52) U.S. Cl. 209/221

(57) ABSTRACT

A magnetic sweeper includes a housing, a handle unit, and a magnetic attracting seat unit. The housing includes an annular wall and a stop plate projecting from an outer surface of the annular wall. The handle unit is connected fixedly to the housing. The magnetic attracting seat unit includes a rotating shaft member disposed coaxially and rotatably within the annular wall and having a magnet-mounting portion and a plurality of housing-retaining portions in frictional contact with an inner surface of the annular wall so as to maintain positioning of the rotating shaft member within the housing. A plurality of magnetic attracting members are disposed fixedly on the magnet-mounting portion, and are arranged along an axial direction of the rotating shaft member. At least one rotary member is connected fixedly to the rotating shaft member, and is disposed outwardly of the housing for manual operation.

### CROSS-REFERENCE TO RELATED APPLICATION

This application claims priority of Taiwanese Application No. 094136481, filed on Oct. 19, 2005.

### BACKGROUND OF THE INVENTION

1. Field of the Invention

This invention relates to a tool for picking up metal objects, and more particularly to a magnetic sweeper that can collect and release metal objects.

2. Description of the Related Art

Metal objects, such as metal nails, nuts, sleeves, washers, screws, springs, thumbtacks, etc., may drop to the ground when in use. In a clean and small space, they can be picked up with bare hands with relative ease. However, it is troublesome to remove such metal objects from a spacious area, such as a yard, a work site, and the beach, or from small and narrow spaces, such as the floor area beneath a car's chassis. There is available a type of magnetic floor sweeper, such as that disclosed in U.S. Pat. No. 2,693,279.

Referring to FIGS. 1 and 2, the magnetic floor sweeper includes a cylindrical shield 1, an axle 2 disposed rotatably within the shield 1, a yoke 3 having two parallel strip portions flanking the shield 1 and connected rotatably to the axle 2, a U-shaped bumper bar 4 having two parallel arms flanking the shield 1 and connected fixedly to the axle 2, an axial row of permanent magnets 5 disposed fixedly on the axle 2, and two wheels 6 sleeved respectively and rotatably on two opposite ends of the axle 2. The shield 1 is provided with a fixed stop flange 101 on an annular outer surface thereof. When a force is applied to the yoke 3 so as to rotate the wheels 6, the shield 1 moves over the ground. Hence, metal objects are attracted onto a bottom portion of the annular outer surface of the shield 1. Referring to FIG. 3, when the bumper bar 4 is pivoted about the axle 2, the metal objects move on the annular outer surface of the shield 1. Upon contact with the stop flange 101, the metal objects are released from the shield 1, and therefore drops to the ground as a result of the simultaneous release of the magnetic attracting force exerted thereon. As such, the metal objects can be collected in a pile at a predetermined area.

In actual use, however, the aforementioned magnetic floor sweeper suffers from the following disadvantages:

(1) Referring to FIG. 2, during use, a bottom end of the bumper bar 4 is spaced apart from the ground by a small distance. As such, metal objects having a height greater than this small distance cannot be attracted onto the shield 1.

(2) Referring to FIG. 4, when the magnetic floor sweeper moves on an inclined surface, the bumper 4 contacts the ground to thereby prevent some metal objects from being attracted onto the shield 1.

(3) During operation of the bumper bar 4, since the fingers of the user must be placed adjacent to the annular outer surface of the shield 1, they may be hurt by the metal objects accumulated on the shield 1, or may even come to be clamped between the bumper bar 4 and the stop flange 101.

### SUMMARY OF THE INVENTION

The object of this invention is to provide a magnetic sweeper that can safely and effectively collect and release metal objects. According to this invention, a magnetic sweeper includes a housing, a handle unit, and a magnetic attracting seat unit. The housing includes an annular wall and a stop plate projecting from an outer surface of the annular wall. The handle unit is connected fixedly to the housing. The magnetic attracting seat unit includes a rotating shaft member disposed coaxially and rotatably within the annular wall and having a magnet-mounting portion and a plurality of housing-retaining portions in frictional contact with an inner surface of the annular wall so as to maintain positioning of the rotating shaft member within the housing. A plurality of magnetic attracting members are disposed fixedly on the magnet-mounting portion, and are arranged along an axial direction of the rotating shaft member. At least one rotary member is connected fixedly to the rotating shaft member, and is disposed outwardly of the housing for manual operation.

Due to frictional contact between the housing and the housing-retaining portions of the rotating shaft member, the position of the magnetic attracting seat unit relative to the housing can be adjusted by rotating the rotary member. Such adjustment may be performed to optimize the attraction of the metal objects toward magnetic sweeper.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a fragmentary schematic front view of a conventional magnetic floor sweeper disclosed in U.S. Pat. No. 2,693,279;

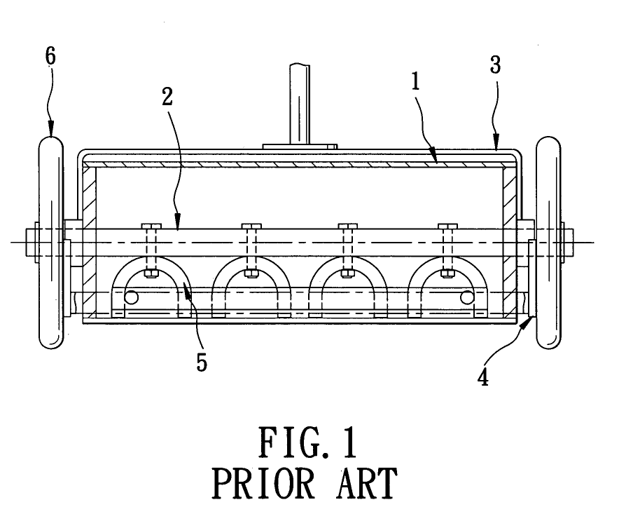

FIG. 2 is a fragmentary schematic side view of the conventional magnetic floor sweeper;

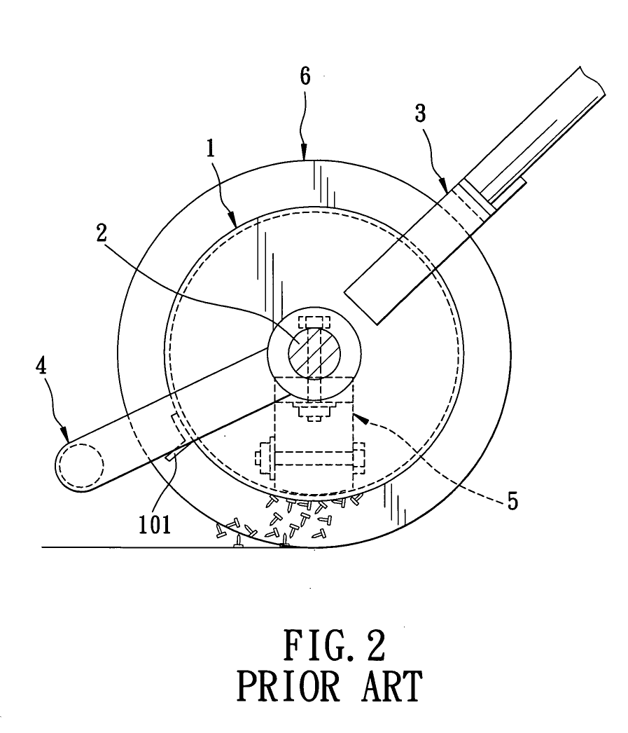

FIG. 3 is a fragmentary schematic side view of the conventional magnetic floor sweeper, illustrating how metal objects are released;

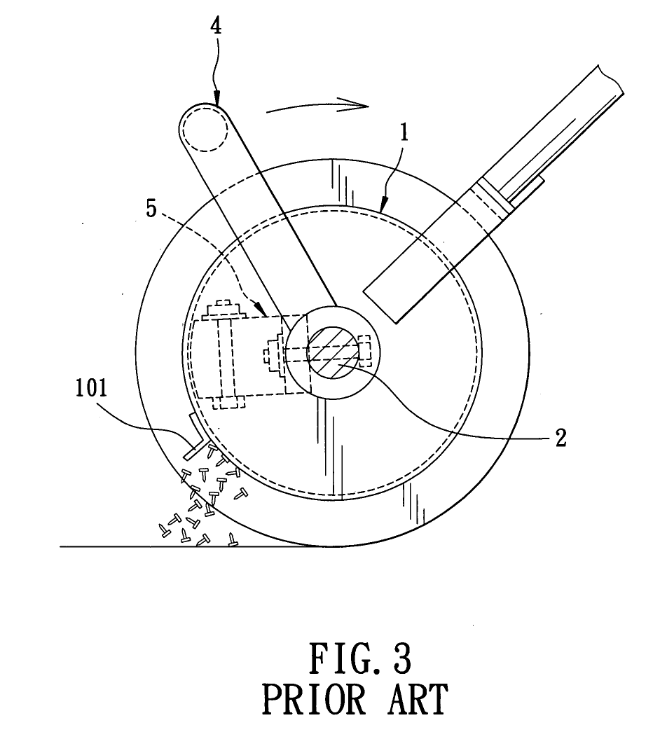

FIG. 4 is a fragmentary schematic side view of the conventional magnetic floor sweeper, illustrating how it is used on a slope;

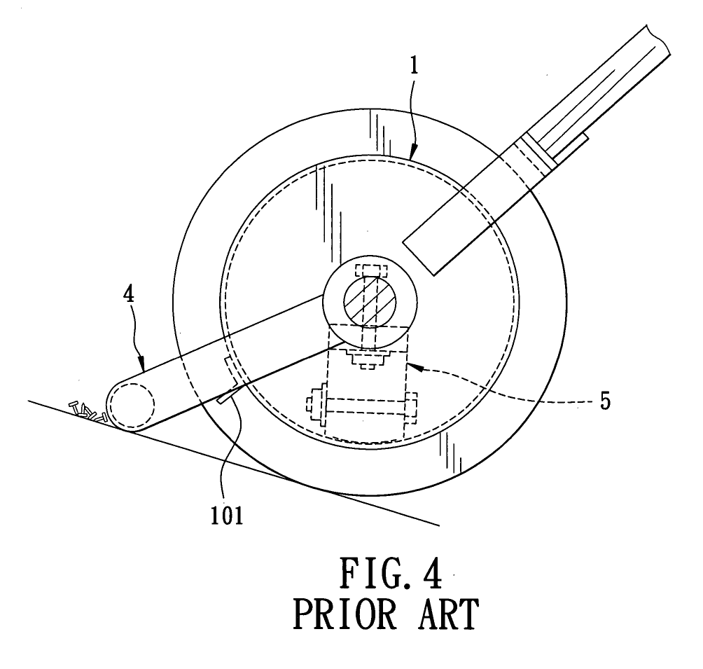

FIG. 5 is an exploded perspective view of the first preferred embodiment of a magnetic sweeper according to this invention;

FIG. 6 is a sectional front view of the first preferred embodiment;

FIG. 7 is a sectional view taken along Line 7-7 in FIG. 6;

FIG. 8 is a sectional view similar to FIG. 7, illustrating the use of rake teeth of the first preferred embodiment;

FIG. 9 is an exploded perspective view of the second preferred embodiment of a magnetic sweeper according to this invention;

FIG. 10 is a fragmentary sectional front view of the second preferred embodiment;

FIG. 11 is a sectional view taken along Line 11-11 in FIG. 10;

FIG. 12 is an exploded perspective view of the third preferred embodiment of a magnetic sweeper according to this invention;

FIG. 13 is a fragmentary sectional front view of the third preferred embodiment; and

FIG. 14 is an exploded perspective view of the fourth preferred embodiment of a magnetic sweeper according to this invention.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

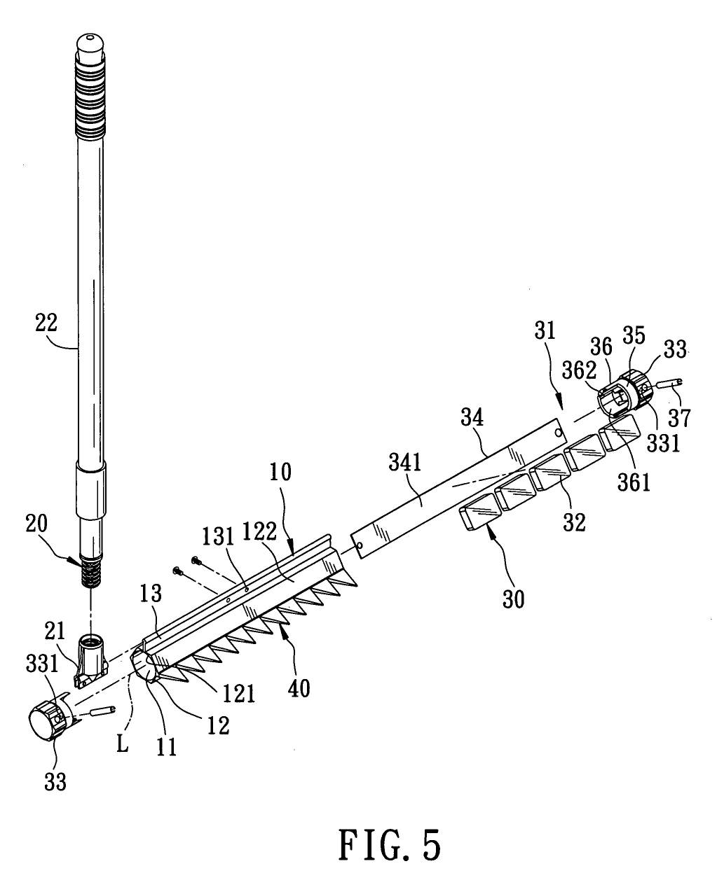

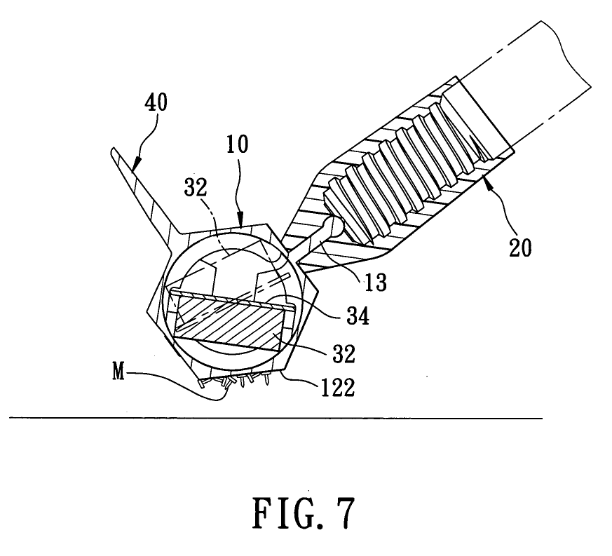

Referring to FIG. 5, the first preferred embodiment of a magnetic sweeper according to this invention is adapted to collect magnetic metal objects (M) (see FIG. 7) (such as metal nails, nuts, sleeves, washers, screws, springs, thumbtacks, etc.) from the ground by magnetic force. The magnetic sweeper includes a housing 10, a handle unit 20 connected fixedly to the housing 10, a magnetic attracting seat unit 30 mounted to the housing 10, and a row of rake teeth 40 disposed fixedly on the housing 10.

The housing 10 includes an annular wall 12 disposed about an axis (L) and defining a circular central hole 11, and a stop plate 13 projecting integrally from an outer surface of the annular wall 12 and extending from one end of the annular wall 12 to the other end of the annular wall 12. The annular wall 12 is cylindrical, and has an annular inner surface 121 defining the central hole 11, and a hexagonal outer surface 122. The stop plate 13 is parallel to the axis (L), and is formed with two holes 131 therethrough.

The handle unit 20 includes a fitting 21 connected fixedly to the stop plate 13, and a grip rod 22 having a lower end connected removably to the fitting 21. A lower end of the fitting 21 is connected to the stop plate 13 by two bolts extending respectively through the holes 131 in the stop plate 13.

The magnetic attracting seat unit 30 includes a rotating shaft member 31 disposed coaxially and rotatably within the central hole 11 in the annular wall 12 of the housing 10, a plurality of magnetic attracting members 32 disposed fixedly on the rotating shaft member 31, and two rotary members 33 connected fixedly to the rotating shaft member 31 and disposed outwardly of the housing 10 so as to allow for manual operation.

The rotating shaft member 31 includes an elongated mounting plate 34 made of a magnetically conductive material, two end caps 35 connected respectively to two opposite ends of the mounting plate 34, and two housing-retaining portions 36 disposed respectively on axial inner ends of the end caps 35. The mounting plate 34 is connected fixedly to the rotary members 33 by two bolts 37, and has a flat magnet-mounting portion 341 for mounting the magnetic attracting members 32 fixedly thereon. Each of the end caps 35 is made of a plastic material, and is formed integrally with the corresponding housing-retaining portion 36 and the corresponding rotary member 33. Each of the housing-retaining portions 36 includes a circumferentially extending wall unit 361 that has an L-shaped slot 362 formed therethrough and that presses against an inner surface of the annular wall 12 of the housing 10 (i.e., in frictional contact with the inner surface of the annular wall 12). As such, positioning of the rotating shaft member 31 within the housing 10 can be maintained. In other words, rotation of the rotating shaft member 31 within the housing 10 is prevented unless an external force is applied to the rotary members 33.

Each of the rotary members 33 is formed with a mark 331 for indicating the angular position of an assembly of the magnetic attracting members 32.

The rake teeth 40 are disposed fixedly on the outer surface of the annular wall 12 of the housing 10, and are arranged along an axial direction of the rotating shaft member 31. In this embodiment, the rake teeth 40 form an angle with respect to the handle unit 20.

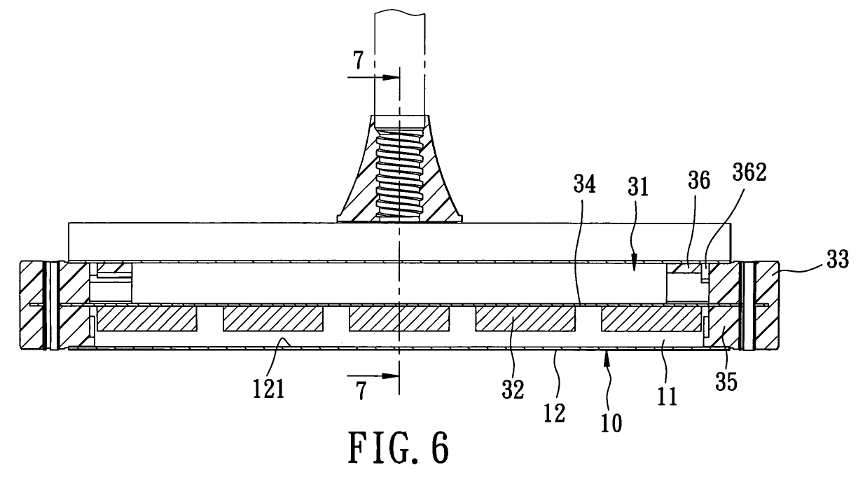

Referring to FIG. 6, the end caps 35 are fitted respectively within two opposite ends of the central hole 11 in the annular wall 12 of the housing 10.

With further reference to FIG. 7, either of the rotary members 33 can be rotated so as to adjust the positions of the magnetic attracting members 32 within the housing 10 according to ground conditions. Thus, the attraction of the magnetic objects (M) onto the housing 10 may be optimized in accordance with the ground conditions. Furthermore, when one of the rotary members 33 is rotated counterclockwise so as to pivot the magnetic attracting members 32 from the position shown by the solid lines in FIG. 7 to that shown by the phantom lines in FIG. 7, the accumulated metal objects (M) come into contact with the stop plate 13 or the handle unit 20. This causes the accumulated metal objects to drop from the housing 10 to the ground as a result of the simultaneous release of the magnetic attracting force exerted thereon.

The first preferred embodiment has the following advantages:

(1) The metal objects (M) can be attracted fully onto the housing 10 even when they have a substantial height.

(2) Since the positions of the magnetic attracting members 32 within the housing 10 can be adjusted, the magnetic sweeper of this invention is suitable for collecting the metal objects (M) from an inclined surface.

(3) When the rotary members 33 are operated to release the metal objects (M) from the housing 10, since they are distal from the metal objects (M), the fingers of the user cannot be hurt by the metal objects (M) or by elements of the magnetic sweeper itself.

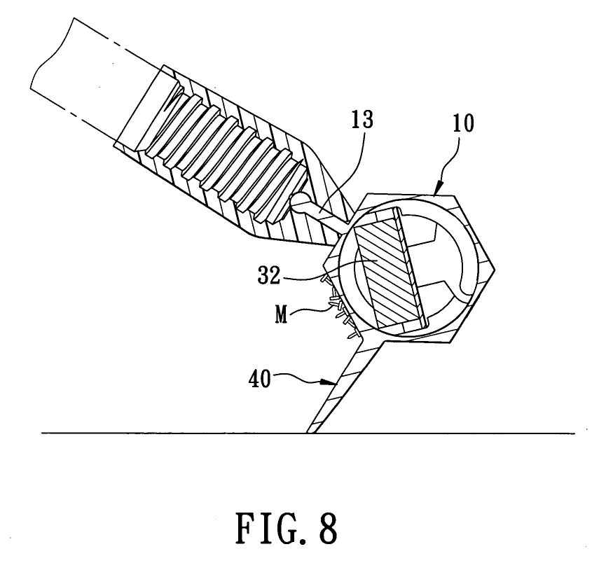

Referring to FIG. 8, when the magnetic sweeper is used on a lawn, on an area covered with sawdust, on a sandy beach, etc., the assembly of the magnetic attracting members 32 can be pivoted to a position between the stop plate 13 and the rake teeth 40. As such, when the rake teeth 40 move to the left on the ground, the metal objects (M) can be attracted onto a portion of the housing 10 located between the stop plate 13 and the rake teeth 40.

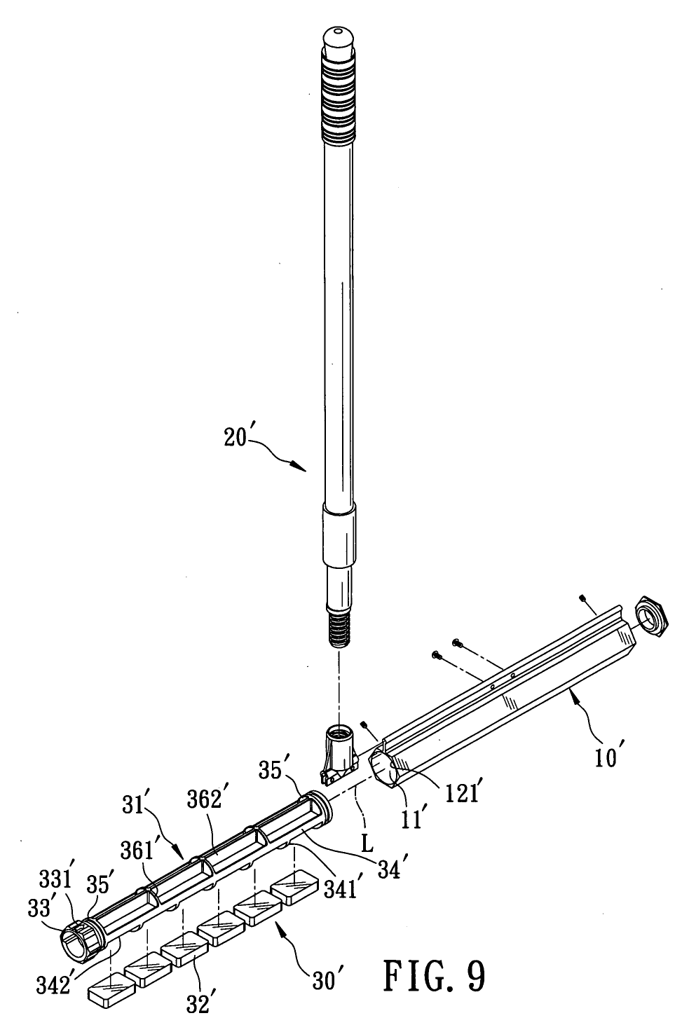

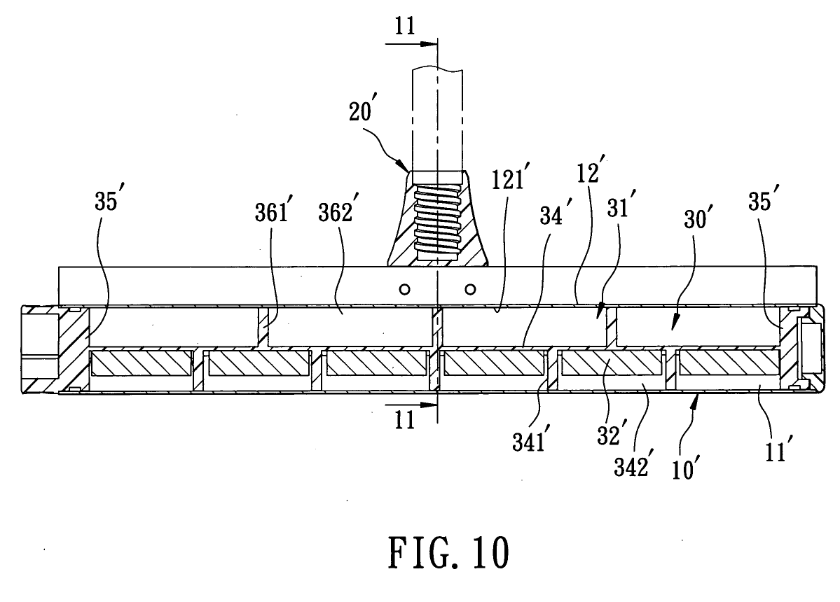

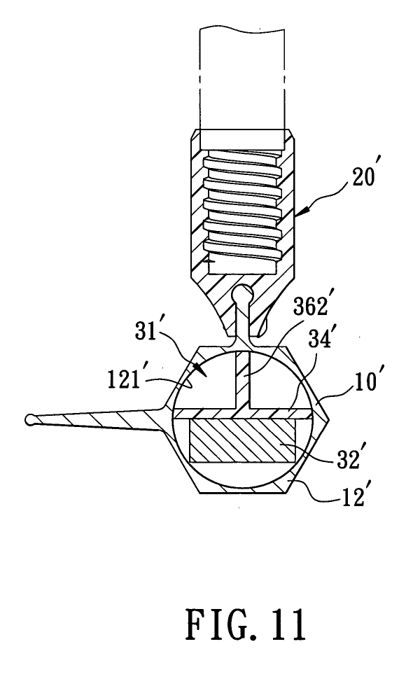

Referring to FIGS. 9, 10, and 11, the second preferred embodiment of a magnetic sweeper according to this invention includes a housing 10′, a handle unit 20′ connected fixedly to the housing 10′, and a magnetic attracting seat unit 30′ mounted to the housing 10′. The handle unit 20′ is similar in construction to the first preferred embodiment. The magnetic attracting seat unit 30′ includes a rotating shaft member 31′ disposed within the central hole 11′ in the housing 10′ and rotatable about the axis (L), a plurality of magnetic attracting members 32′ disposed fixedly on the rotating shaft member 31′, and a unitary rotary member 33′ connected fixedly to the rotating shaft member 31′ and disposed outwardly of the housing 10′. The rotating shaft member 31′ is made of a flexible plastic material, and includes an elongated mounting plate 34′ mounted fixedly with the magnetic attracting members 32′, and two end caps 35′ formed respectively and integrally with two opposite ends of the mounting plate 34′. One of the end caps 35′, is connected integrally to the rotary member 33′. The rotating shaft member 31′ has a bottom surface formed with a modified magnet-positioning portion, and a top surface formed with a plurality of modified housing-retaining portions. The modified magnet-positioning portion includes a plurality of transverse plates 341′, each adjacent pair of which defines a magnet receiving space 342′ therebetween. The magnetic attracting members 32′ are mounted fixedly to the bottom surface of the mounting plate 34′, and are disposed respectively within the magnet receiving space 342′. The modified housing-retaining portions include a plurality of transverse plates 361′ and a plurality of axial plates 362′ that are aligned with each other along an axial direction of the housing 10′ and that are perpendicular to the transverse plates 361′. Each of the axial plates 362′ has two ends formed respectively and integrally with two adjacent transverse plates 361′, and a radial outer side in frictional contact with an annular inner surface 121′ of an annular wall 12′ of the housing 10′, as shown in FIG. 11. Each of the transverse plates 361′ has a curved outer periphery in frictional contact with the inner surface 121′ of the annular wall 12′ of the housing 10′, as shown in FIG. 10. The transverse plates 341′, 361′ have the same function.

The rotary member 33′ is formed with a mark 331′ for indicating the angular position of an assembly of the magnetic attracting members 32′.

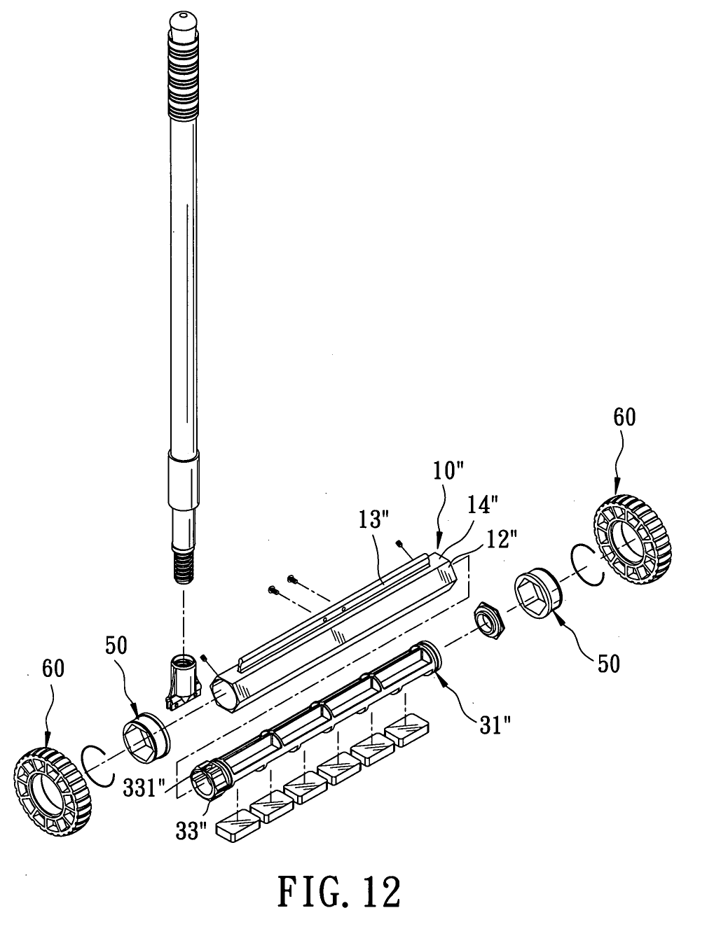

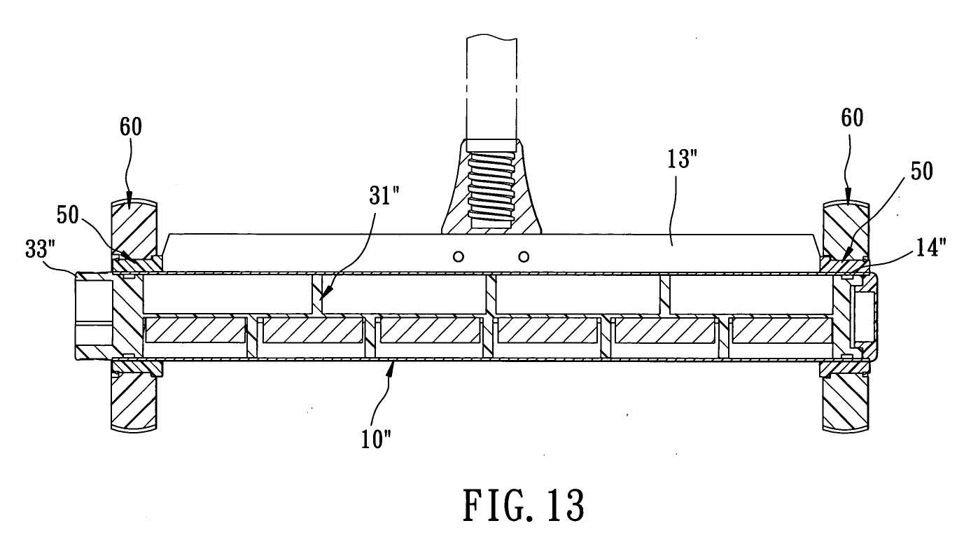

FIGS. 12 and 13 show the third preferred embodiment of a magnetic sweeper according to this invention, which is similar in construction to the second preferred embodiment. In contrast to the second preferred embodiment, the stop plate 13″ is shortened, and projects from an intermediate portion of the annular wall 12″ of the housing 10″. As such, two insert portions 14″ are defined respectively at two ends of the housing 10″. This embodiment further includes two sleeve members 50 sleeved respectively on the insert portions 14″ and abutting respectively against two opposite ends of the stop plate 13″, and two wheels 60 sleeved respectively and rotatably on the sleeve members 50. The rotary member 33″ is connected fixedly to the rotating shaft member 31″, extends outwardly from the corresponding wheel 60, and is formed with a mark 331″.

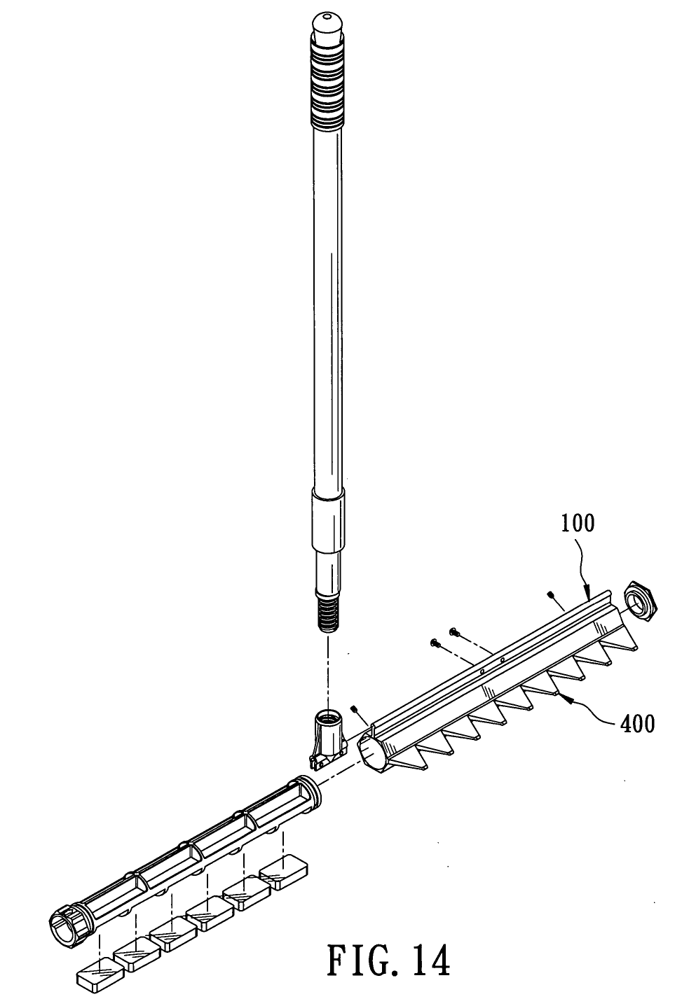

FIG. 14 shows the fourth preferred embodiment of a magnetic sweeper according to this invention, which is also similar in construction to the second preferred embodiment except that the housing 100 further includes a row of rake teeth 400 disposed fixedly on an outer surface thereof in the same manner as the first preferred embodiment.

With this invention thus explained, it is apparent that numerous modifications and variations can be made without departing from the scope and spirit of this invention. It is therefore intended that this invention be limited only as indicated by the appended claims.

I claim:

1. A magnetic sweeper comprising:
a housing including
an annular wall disposed about an axis and defining a central hole, and
a stop plate projecting from an outer surface of said annular wall;
a handle unit connected fixedly to said housing; and
a magnetic attracting seat unit including
a rotating shaft member disposed coaxially and rotatably within said central hole in said annular wall of said housing and including a magnet-mounting portion and a plurality of housing-retaining portions in frictional contact with an inner surface of said annular wall of said housing so as to maintain positioning of said rotating shaft member within said housing,
a plurality of magnetic attracting members disposed fixedly on said magnet-mounting portion of said rotating shaft member and arranged along an axial direction of said rotating shaft member, and
at least one rotary member connected fixedly to said rotating shaft member and disposed outwardly of said housing so as to allow for manual operation to rotate said rotating shaft member within said housing.

2. The magnetic sweeper as claimed in claim 1, wherein said rotating shaft member of said magnetic attracting seat unit further includes an elongated mounting plate made of a magnetically conductive material and having said magnet-mounting portion, and two end caps connected respectively and fixedly to two opposite ends of said mounting plate and connected respectively and integrally to said rotary members, each of said housing-retaining portions of said rotating shaft member being made of a plastic material and including a circumferentially extending wall unit that has an L-shaped slot formed therethrough, and that presses against said inner surface of said annular wall of said housing, said housing-retaining portions of said rotating shaft member being disposed respectively on axial inner ends of said end caps.

3. The magnetic sweeper as claimed in claim 2, wherein said handle unit includes a fitting connected fixedly to said stop plate, and a grip rod having a lower end connected removably to said fitting.

4. The magnetic sweeper as claimed in claim 1, further comprising a row of rake teeth disposed fixedly on said outer surface of said annular wall of said housing and arranged along the axial direction of said rotating shaft member, said rake teeth forming an angle with respect to said handle unit.

5. The magnetic sweeper as claimed in claim 1, wherein said rotating shaft member of said magnetic attracting seat unit is unitary, and is made of a flexible plastic material, said rotating shaft member further including an elongated mounting plate mounted fixedly with said magnetic attracting members, and two end caps formed respectively and integrally with two opposite ends of said mounting plate, one of said end caps being connected integrally to said rotary member, each of said housing-retaining portions including a plurality of transverse plates and a plurality of aligned axial plates perpendicular to said transverse plates, each of axial plates having two ends formed respectively and integrally with two adjacent ones of said transverse plates, and a radial outer side in frictional contact with said inner surface of said annular wall of said housing, each of said transverse plates having a curved outer periphery in frictional contact with said inner surface of said annular wall of said housing.

6. The magnetic sweeper as claimed in claim 5, wherein said handle unit includes a fitting connected fixedly to said stop plate, and a grip rod having a lower end connected removably to said fitting.

7. The magnetic sweeper as claimed in claim 5, further comprising two sleeve members sleeved respectively and fixedly on two opposite ends of said housing, and two wheels sleeved respectively and rotatably on said sleeve members, said rotary member extending outwardly from a corresponding one of said wheels.

8. The magnetic sweeper as claimed in claim 5, further comprising a row of rake teeth disposed fixedly on said outer surface of said annular wall of said housing and arranged along the axial direction of said rotating shaft member, said rake teeth forming an angle with respect to said handle unit.
